(19) United States
(12) Patent Application Publication
(10) Pub. No.: US 2021/0370105 A1
(43) Pub. Date: Dec. 2, 2021

(54) AIR INHALATION AND EXHALATION FILTERING MASK

(71) Applicant: Roy CHEN, Taichung City (TW)

(72) Inventor: Roy CHEN, Taichung City (TW)

(21) Appl. No.: 16/887,821

(22) Filed: May 29, 2020

(51) Int. Cl. A62B 23/02; B01D 46/10; B01D 46/00; B01D 53/04; A41D 13/11; A62B 18/02

(52) U.S. Cl. CPC A62B 23/02; B01D 46/10; B01D 46/0036; B01D 46/0038; B01D 53/04; A41D 2400/36; A41D 13/1161; A62B 18/025; B01D 2253/102; B01D 2259/4541; A41D 13/1138

(57) ABSTRACT

An air inhalation and exhalation filtering mask has a mask body, an inhalation device, an exhalation device, and first and second filtering structures, wherein, on the middle portion of the mask body, first and second openings are respectively configured at an upper and a lower position. The inhalation device is configured on the mask body and covers the first opening. Air flows from the front side of the mask body, passing through the inhalation device, and flows to the rear side. The exhalation device is configured on the mask body and covers the second opening. Air flows from the rear side of the mask body, passing through exhalation device and flows to the front side. The first filtering structure filters air flowing to the rear side of the mask body, while the second filtering structure filters air flowing to the front side of the mask body.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a mask, and more particularly to an innovative structural design of an air inhalation and exhalation filtering mask.

### 2. Description of Related Art Including Information Disclosed Under 37 CFR 1.97 and 37 CFR 1.98

Various air-borne particulates like aerosols, viruses and bacteria may easily invade the human body via the respiratory tract and cause allergy, asthma and other diseases. To minimize hazards from the above particulates, wearing a mask is an easy and effective preventive action.

A conventional mask is mainly made up of a mask body and two fixing cords. The fixing cords are configured respectively on the two sides of the mask body. When wearing a conventional mask, the mask body covers the mouth and nose portions of the user and the fixing cords are respectively hooked on the ears of the user. The mask body is used to block the air-borne particulates, stopping them from invading the body via the respiratory tract of the user.

The effect of the mask body filtering the particulates depends on the density of the mask material. Materials with higher density provide smaller pores for air to pass through and can filter particulates of smaller sizes, but on the other hand, provide lower air permeability, causing uncomfortable feelings like unsmooth breath or sultriness. The requirement for maintaining proper air permeability limits the texture of the mask body, and the effect of filtering air-borne particulates is compromised.

There is another kind of mask with two breather vents configured on the mask body. Each of the breather vents is configured respectively on the left side and right side. Each of the breather vents is configured with a filtering material. Air will pass through the breather vents, and the filtering material will filter the air passing through the breather vents. Such a mask body has no requirement for air permeability, but can effectively block the air-borne particulates. By adopting appropriate filtering materials for usage in different environments, this kind of mask body can meet various usage requirements.

However, in actual applications, it is found that this kind of mask structure still has the following problems: because each of the breather vents is configured respectively on the left side and right side, there is some distance between the breather vents and the mouth and nose of the user, and the air flowing between the breather vents and the mouth and nose has a turning flow path, which may easily cause unsmooth breath.

### BRIEF SUMMARY OF THE INVENTION

The main object of the present invention is to provide an air inhalation and exhalation filtering mask, aiming to solve the above-mentioned problem and develop an ideally practical new style of air inhalation and exhalation filtering mask that can effectively filter airborne particulates while ensuring easy breathing.

Based on the above object, the present invention provides an air inhalation and exhalation filtering mask that includes a mask body, being made of non-breathable material, having a first opening and a second opening configured on its middle portion. The first opening and second opening are positioned one above the other; the mask body is configured with a first connecting base on its first opening, and a second connecting base on its second opening.

An inhalation device is configured on the front side of the mask body, covering the first opening, so that air can flow from the front side of the mask body, passing through the inhalation device, and flow to the rear side of the mask body.

Said inhalation device comprises a first shell body, a first front cover, a first fan, a first controller and a first battery. The first shell body is configured on the front side of the mask body, and the first shell body is attached to the first connecting base through threaded connection. The first front cover is configured on the front side of the first shell body, and is attached to the first shell body through threaded connection. The first front cover is provided with a plurality of air inlets. The first fan is configured inside the first shell body. The first controller and the first battery are configured on the first front cover. The first controller is coupled to the first fan. The first battery is coupled to the first controller. The first controller controls the operation of the first fan, so that the first fan will introduce air through the air inlets, and will push the air toward the first opening.

An exhalation device is configured on the front side of the mask body. The exhalation device covers the second opening, so that air will flow from the rear side of the mask body, passing through the exhalation device, and flow to the front side of the mask body.

The exhalation device comprises a second shell body, a second front cover, a second fan, a second controller and a second battery. The second shell body is configured on the front side of the mask body and is attached to the second connecting base through threaded connection. The second front cover is configured on the front side of the second shell body, and is attached to the second shell body through threaded connection. The second front cover is provided with a plurality of exhaust vents. The second fan is configured inside the second shell body. The second controller and the second battery are configured on the second front cover. The second controller is coupled to the second fan. The second battery is coupled to the second controller. The second controller controls the operation of the second fan, so that the second fan will introduce air from the second opening, and discharge the air to the exhaust vents.

A first filtering structure is configured on the front side of the first fan, so as to filter the air flowing to the rear side of the mask body.

A second filtering structure is configured on the rear side of the second fan, so as to filter the air flowing to the front side of the mask body.

Based on the above-mentioned innovative structural design and technical characteristics, the present invention makes a practical advance over the prior art to enhance the ease of breathing.

### BRIEF DESCRIPTION OF THE SEVERAL VIEWS OF THE DRAWINGS

FIG. 1 is a perspective view of Embodiment 1 of the present invention.

FIG. 2 is an exploded perspective view of Embodiment 1 of the present invention.

FIG. 3 is a sectional view of the inhalation device in Embodiment 1 of the present invention.

FIG. 4 is a sectional view of the exhalation device in Embodiment 1 of the present invention.

FIG. 5 is a partially enlarged view of the first snap plate in FIG. 1.

FIG. 6 is a partially enlarged view of the second snap plate in FIG. 1.

FIG. 7 is an operational view of Embodiment 1 of the present invention.

FIG. 8 is a perspective view of the inhalation device and exhalation device detached from the mask body of Embodiment 1 of the present invention.

FIG. 9 is partial perspective view of Embodiment 2 of the present invention.

### DETAILED DESCRIPTION OF THE INVENTION

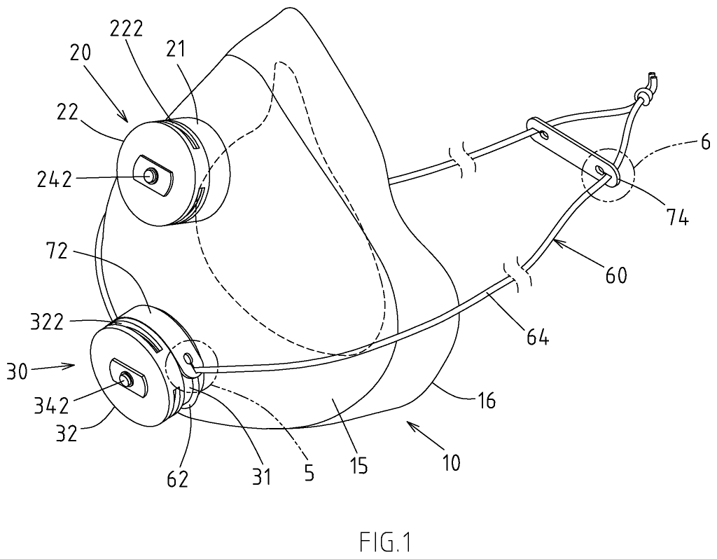

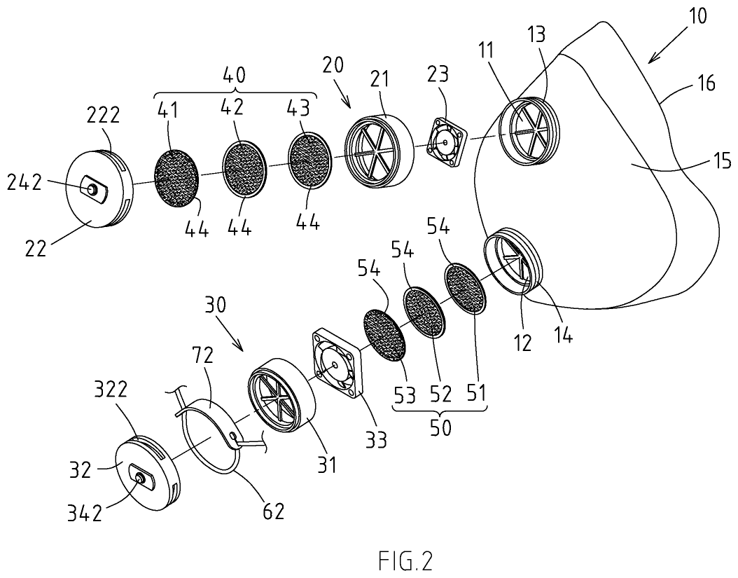

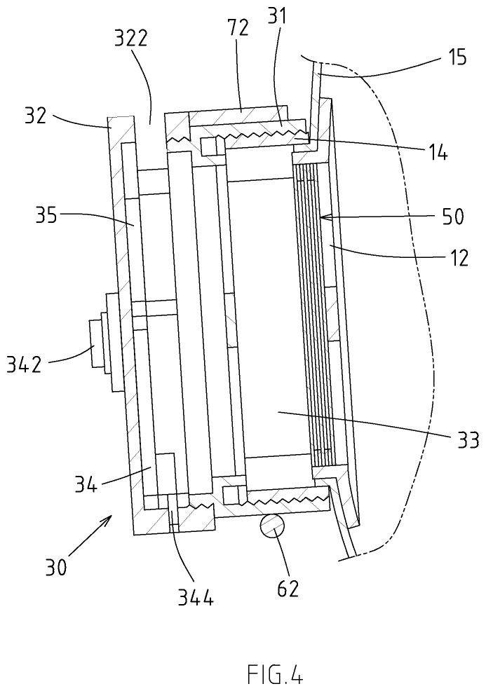

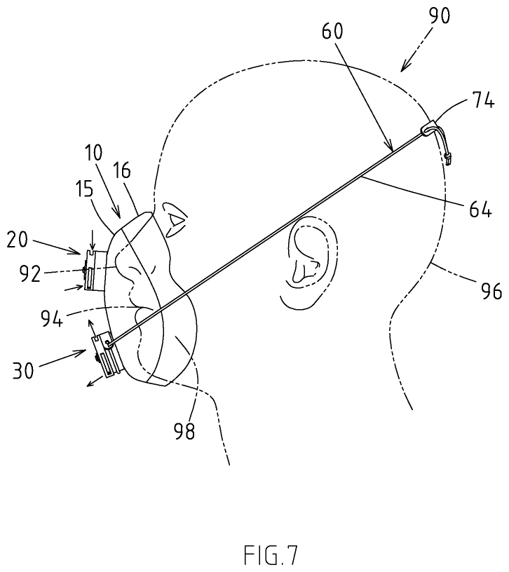

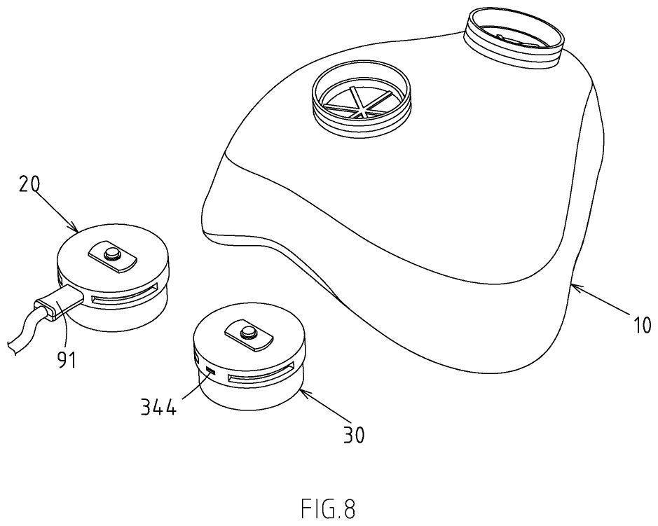

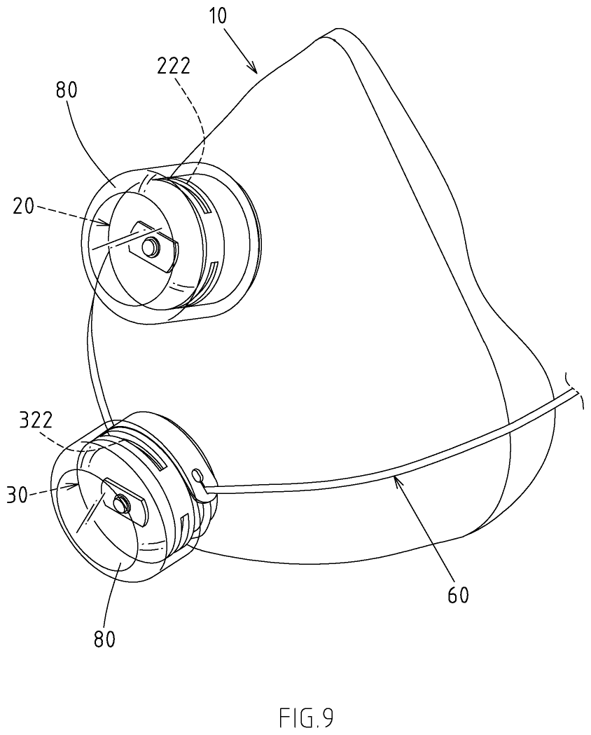

Disclosed in FIG. 1 to FIG. 9 is an embodiment of the present invention of an air inhalation and exhalation filtering mask. It is to be understood, however, that such an embodiment is for the purpose of description only, and is not intending to limit the scope of the present invention.

As depicted in FIG. 1 to FIG. 8, Embodiment 1 of the air inhalation and exhalation filtering mask comprises a mask body 10, an inhalation device 20, an exhalation device 30, a first filtering structure 40 and a second filtering structure 50, wherein said mask body 10 is made of non-breathable material. The mask body 10 has a first opening 11 and a second opening 12 configured on its middle portion. The first opening 11 and the second opening 12 are positioned one above the other. The mask body 10 is configured with a first connecting base 13 on its first opening 11. The mask body 10 is configured with a second connecting base 14 on its second opening 12. The inhalation device 20 is configured on the front side of the mask body 10, and the inhalation device 20 covers the first opening 11, so that air can flow from the front side of the mask body 10, passing through the inhalation device 20, and flow to the rear side of the mask body 10. The exhalation device 30 is configured on the front side of the mask body 10, and the exhalation device 30 covers the second opening 12, so that air can flow from the rear side of the mask body 10, passing through the exhalation device 30, and flow to the front side of the mask body 10.

The inhalation device 20 comprises a first shell body 21, a first front cover 22, a first fan 23, a first controller 24 and a first battery 25. The first shell body 21 is configured on the front side of the mask body 10, and is attached to the first connecting base 13 through threaded connection, so that the inhalation device 20 is separated from the first connecting base 13, and the inhalation device 20 can be repaired or replaced. The first front cover 22 is configured on the front side of the first shell body 21, and is attached to the first shell body 21 through threaded connection. The first front cover 22 is provided with a plurality of air inlets 222. The first fan 23 is configured inside the first shell body 21. The first controller 24 and the first battery 25 are configured on the first front cover 22. The first controller 24 is made of an electronic circuit. The first controller 24 is coupled to the first fan 23. The first battery 25 is coupled to the first controller 24. The first battery 25 supplies power for the fan 23 to operate. The first controller 24 controls the operation of the first fan 23, so that the first fan 23 can take in the air on the front side of the mask body 10 through the air inlets 222, and push the air towards the first opening 11.

The exhalation device 30 comprises a second shell body 31, a second front cover 32, a second fan 33, a second controller 34 and a second battery 35. The second shell body 31 is configured on the front side of the mask body 10, and is attached to the second connecting base 14 through threaded connection, so that the exhalation device 30 can be separated from the second connecting base 14, and the exhalation device 30 can be repaired or replaced. The second front cover 32 is configured on the front side of the second shell body 31, and is attached to the second shell body 31 through threaded connection. The second front cover 32 is provided with a plurality of exhaust vents 322. The second fan 33 is configured inside the second shell body 31. The second controller 34 and the second battery 35 are configured on the second front cover 32. The second controller 34 is made of an electronic circuit. The second controller 34 is coupled to the second fan 33. The second battery 35 is coupled to the second controller 34. The second battery 35 supplies the power for the second fan 33 to operate. The second controller 34 controls the operation of the second fan 33, so that the second fan 33 can take in the air on the rear side of the mask body 10 via the second opening 12, and discharge the air to the exhaust vents 322.

The first filtering structure 40 is configured on the front side of the first fan 23, so as to filter the air flowing to the mask body 10. The second filtering structure 50 is configured on the rear side of the second fan 33, so as to filter the air flowing to the front side of the mask body 10.

Based on the above structural composition and technical characteristics, the operation of the present invention is as described below: The mask body 10 covers the nose portion 92 and mouth portion 94 of the user 90. Because the first opening 11 and the second opening 12 are positioned one above the other, the first opening 11 faces the nose portion 92, and the second opening 12 faces the mouth portion 94. The inhalation device 20 and the exhalation device 30 operate independently. The inhalation device 20 takes in air from the outside, and pushes the outside air towards the nose portion 92. The exhalation device 30 sucks the air exhaled from the mouth portion 94 and discharges the air to the outside. The air flowing paths between the first opening 11 and the nose portion 92 as well as between the second opening 12 and the mouth portion 94 are short and straight. Therefore, the breath easiness of the user 90 can be enhanced.

The first filtering structure 40 is configured on the front side of the first fan 23. Various particulates contained in the external air are blocked by the first filtering structure 40, and will not adhere to the first fan 23. The second filtering structure 50 is configured on the rear side of the second fan 33. The particulates contained in the air exhaled by the user 90 are blocked by the second filtering structure 50, and will not adhere to the second fan 33; Furthermore, by twisting the first shell body 21 to release its threaded connection with the first front cover 22, the first filtering structure 40 and the first battery 25 can be replaced. By twisting the second shell body 31 to release its threaded connection with the second connecting base 14, the second filtering structure 50 can be replaced. By twisting the second shell body 31 to release its threaded connection with the second front cover 32, the second battery 35 can be replaced.

The first filtering structure 40 comprises a first blocking layer 41, a first active carbon layer 42 and a first aromatic layer 43, wherein the first aromatic layer 43 is configured on the rear side of the first blocking layer 41, and the first active carbon layer 42 is positioned between the first blocking layer 41 and the first aromatic layer 43. The first blocking layer 41, the first active carbon layer 42, and the first aromatic layer 43 are respectively configured with a ring-shaped first magnetic piece 44, so that the first blocking layer 41, the first active carbon layer 42, and the first aromatic layer 43 are bonded together through magnetic force.

The first blocking layer 41 is used to block the aerosols and particulates from the environment. The first active carbon layer 42 is used to further absorb the particulates unblocked by the first blocking layer 41. The first aromatic layer 43 contains essential oil that can emit phytoncid. Thus, the first filtering structure 40 can filter the aerosols and particulates carried by the external air, and supply clean air with comfortable aroma to the nose portion 92. The user wearing the mask will have better comfort.

The second filtering structure 50 comprises a second blocking layer 51, a second active carbon layer 52 and a second aromatic layer 53, wherein the second aromatic layer 53 is configured on the front side of the second blocking layer 51, and the second active carbon layer 52 is positioned between the second blocking layer 51 and the second aromatic layer 53. The second blocking layer 51, the second active carbon layer 52 and the second aromatic layer 53 are respectively configured with a ring-shaped second magnetic piece 54, so that the second blocking layer 51, the second active carbon layer 52, and the second aromatic layer 53 are bonded together through magnetic force.

The second blocking layer 51 is used to block the aerosols and particulates from the user 90. The second active carbon layer 52 is used to further absorb the particulates unblocked by the second blocking layer 51. The second aromatic layer 53 contains essential oil that can emit phytoncid. Thus, the second filtering structure 50 can filter the aerosols and particulates exhaled by the user 90, and the air exhaled by the user 90 will flow out with a comfortable aroma.

The present embodiment further comprises an elastic fastening strap 60, a first snap plate 72, and a second snap plate 74, wherein the fastening strap 60 is joined end to end, and the fastening strap 60 goes through the first snap plate 72 to form a first loop portion 62. The first loop portion 62 goes around the second shell body 31, and the second front cover 32 forms a stop catch against the first loop portion 62. The fastening strap 60 goes through the second snap plate 74. The fastening strap 60 forms a second loop portion 64 between the first snap plate 72 and the second snap plate 74, so that the second loop portion 64 can be hooked on the head portion 96 of the user 90.

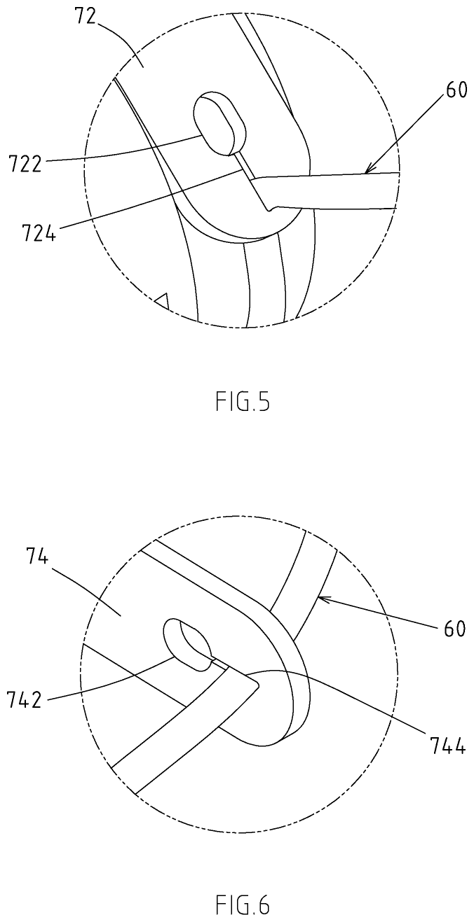

As depicted in FIG. 5, the first snap plate 72 is configured with two first perforations 722 and two first slots 724. The first perforations 722 are respectively adjacent to the two sides of the first snap plate 72. Each of the first slots 724 is communicated with each of the first perforations 722. The width of the first slots 724 is lower than that of the first perforations 722. The fastening strap 60 goes through the rear side of the first perforations 722 and slides into the first slots 724, so that the fastening strap 60 goes through and is caught by the first slots 724; As depicted in FIG. 6, the second snap plate 74 is configured with two second perforations 742 and two second slots 744. The second perforations 742 are respectively adjacent to the two sides of the second snap plate 74. Each of the second slots 744 is respectively communicated with each of the second perforations 742. The width of the second slots 744 is lower than that of the second perforations 742. The fastening strap 60 goes through the rear side of the second perforations 742 and slides into the second slots 744, so that the fastening strap 60 goes through and is caught by the second slots 744.

The mask body 10 is mainly made up of a shielding portion 15 and a contacting portion 16. The shielding portion 15 is a hard shell body, so that a space is formed between the shielding portion 15 and the face portion 98 of the user 90 for air to flow. The contacting portion 16 is ring-shaped and made of soft elastic material. The contacting portion 16 is configured on periphery of the rear side of the shielding portion 15, so as to fit the face portion 96.

The first controller 24 is configured with a first button 242 to control the operation of the first fan 23. The second controller 34 is configured with a second button 342 to control the operation of the second fan 33. The first controller 24 is configured with a first socket 244 for connection with a charging cable 91, so that the first controller 24 can be connected to an external power supply (not shown in the figure) to charge the first battery 25. The second controller 34 is configured with a second socket 344 for connection with another charging cable (not shown in the figure), so that the second controller 34 can be connected to an external power supply to charge the second battery 35.

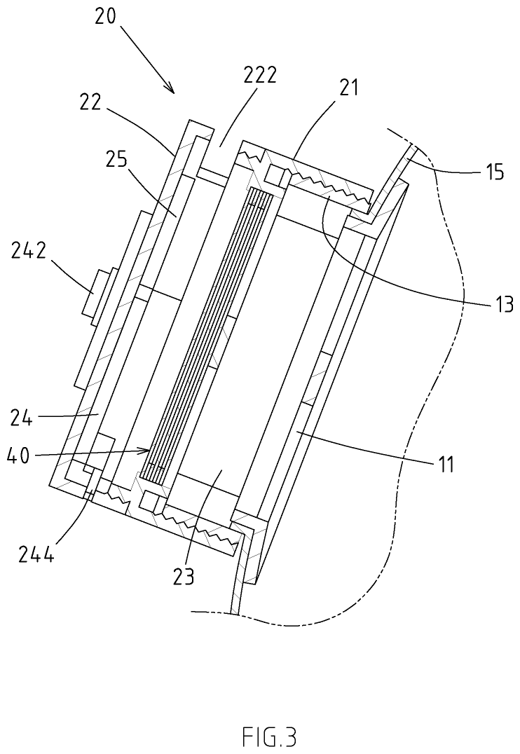

As depicted in FIGS. 3, 4, and 8, both the inhalation device 20 and the exhalation device 30 can be detached from the mask body 10, so that the inhalation device 20 and the exhalation device 30 can be easily repaired. By connecting a charging cable 91 to the first socket 244, the first battery 25 can be charged by an external power supply (not shown in the figure). The second socket 344 can also be connected with a charging cable to charge the second battery 35. When the inhalation device 20 and the exhalation device 30 are detached from the mask body 10, the mask body 10 can be washed, cleaned and sterilized.

Referring to FIG. 9, Embodiment 2 is mainly based on Embodiment 1 as described above. It further comprises two protective caps 80. Each of the protective caps 80 respectively covers the inhalation device 20 and the exhalation device 30, so as to seal the air inlets 222 and the exhaust vents 322. Through the configuration of the protective caps 80, when the mask is put away, it can stop foreign objects from entering the air inlets 222 and the exhaust vents 322. In this embodiment, the protective caps 80 are made of transparent materials.

I claim:

1. An air inhalation and exhalation filtering mask, comprising:
a mask body, being made of non-breathable material, having a first opening and a second opening configured on its middle portion; said first opening and the second opening are positioned one above the other; said mask body is configured with a first connecting base on its first opening, and a second connecting base on its second opening;
an inhalation device, configured on the front side of the mask body, covering the first opening, so that air can flow from the front side of the mask body, passing through the inhalation device, and flow to the rear side of the mask body;
said inhalation device comprises a first shell body, a first front cover, a first fan, a first controller and a first batter; said first shell body is configured on the front side of the mask body, and the first shell body is attached to the first connecting base through threaded connection; said first front cover is configured on the front side of the first shell body, and is attached to the first shell body through threaded connection; said first front cover is provided with a plurality of air inlets; said first fan is configured inside the first shell body; the first controller and the first battery are configured on the first front cover; said first controller is coupled to the first fan; said first battery is coupled to the first controller; said first controller controls the operation of the first fan, so that the first fan will introduce air through the air inlets and will push the air toward the first opening;
an exhalation device, configured on the front side of the mask body; the exhalation device covers the second opening, so that air can flow from the rear side of the mask body, passing through the exhalation device, and flow to the front side of the mask body;
the exhalation device comprises a second shell body, a second front cover, a second fan, a second controller and a second battery; said second shell body is configured on the front side of the mask body and is attached to the second connecting base through threaded connection; said second front cover is configured on the front side of the second shell body, and is attached to the second shell body through threaded connection; said second front cover is provided with a plurality of exhaust vents; said second fan is configured inside the second shell body; said second controller and the second battery are configured on the second front cover; said second controller is coupled to the second fan; said second battery is coupled to the second controller; said second controller controls the operation of the second fan, so that the second fan will introduce air from the second opening, and discharge the air to the exhaust vents;
a first filtering structure, configured on the front side of the first fan, so as to filter the air flowing to the rear side of the mask body; and
a second filtering structure, configured on the rear side of the second fan, so as to filter the air flowing to the front side of the mask body.

2. The air inhalation and exhalation filtering mask defined in claim 1, wherein said first filtering structure comprises a first blocking layer to block aerosols and particulates from the environment, whereas the second filtering structure comprises a second blocking layer to block the aerosols and particulates from the user.

3. The air inhalation and exhalation filtering mask defined in claim 2, wherein said first filtering structure further comprises a first aromatic layer; said first aromatic layer is configured on the rear side of the first blocking layer; said first aromatic layer contains essential oil that can emit phytoncid; said second filtering structure further comprises a second aromatic layer; said second aromatic layer is configured on the front side of the second blocking layer; said second aromatic layer contains essential oil that can emit phytoncid.

4. The air inhalation and exhalation filtering mask defined in claim 3, wherein said first filtering structure further comprises a first active carbon layer; said first active carbon layer is located between the first blocking layer and the first aromatic layer; said second filtering structure further comprises a second active carbon layer; said second active carbon layer is located between the second blocking layer and the second aromatic layer.

5. The air inhalation and exhalation filtering mask defined in claim 4, wherein said first blocking layer, the first active carbon layer, and the first aromatic layer are bonded together through magnetic force; said second blocking layer, the second active carbon layer, and the second aromatic layer are bonded together through magnetic force.

6. The air inhalation and exhalation filtering mask defined in claim 5, wherein said first blocking layer, the first active carbon layer, and the first aromatic layer are respectively configured with a ring-shaped first magnetic piece, so that the first blocking layer, the first active carbon layer, and the first aromatic layer are bonded together through magnetic force; said second blocking layer, the second active carbon layer, and the second aromatic layer are respectively configured with a ring-shaped second magnetic piece, so that the second blocking layer, the second active carbon layer, and the second aromatic layer are bonded together through magnetic force.

7. The air inhalation and exhalation filtering mask defined in claim 1, which further comprises an elastic fastening strap, a first snap plate, and a second snap plate; said fastening strap is connected end to end, and the fastening strap goes through the first snap plate to form a first loop portion; said first loop portion goes around the second shell body, and the second front cover forms a stop catch against the first loop portion; said fastening strap goes through the second snap plate; said fastening strap forms an adjustable second loop portion between the first snap plate and the second snap plate, so that the second loop portion can be hooked on the head portion of the user; said first snap plate is configured with two first perforations and two first slots; said first perforations are respectively adjacent to the two sides of the first snap plate; each of the first slots is communicated with each of the first perforations; the width of the first slots is lower than that of the first perforations; the fastening strap goes through and is caught by the first slots; said second snap plate is configured with two second perforations and two second slots; said second perforations are respectively adjacent to the two sides of the second snap plate; each of the second slots is communicated with each of the second perforations; the width of the second slot is lower than that of the second perforations; the fastening strap goes through and is caught by the second slot.

8. The air inhalation and exhalation filtering mask defined in claim 1, which further comprises two protective caps; the protective caps respectively cover the inhalation device and the exhalation device to respectively seal the air inlets and the exhaust vents.
